(19) United States
(12) Patent Application Publication
(10) Pub. No.: US 2024/0202552 A1
(43) Pub. Date: Jun. 20, 2024

(54) USING A LOGICAL TREE STRUCTURE TO IDENTIFY A FOUNDATION MODEL INFERENCING SERVER FOR FULFILLING AN INFERENCING REQUEST

(71) Applicant: International Business Machines Corporation, Armonk, NY (US)

(72) Inventors: Mudhakar Srivatsa, White Plains, NY (US); Satishkumar Sadagopan, Leawood, KS (US); Utpal Mangla, Toronto (CA); Dinesh C. Verma, New Castle, NY (US); Gerald Coon, Durham, NC (US); Mathews Thomas, Flower Mound, TX (US)

(21) Appl. No.: 18/083,300

(22) Filed: Dec. 16, 2022

(51) Int. Cl. G06N 5/04

(52) U.S. Cl. CPC G06N 5/04

(57) ABSTRACT

A computer-implemented method, according to one embodiment, includes determining a plurality of downstream task models of a foundation model, and arranging the downstream task models into a logical tree structure. Each node of the logical tree structure represents a sequence of layers of an associated one of the downstream task models. In response to a determination that a request for inferencing on a target model has resulted in a cache miss occurring, the logical tree structure is used to identify an inferencing server that satisfies at least a first predetermined prerequisite for fulfilling the inferencing request. The method further includes causing the identified inferencing server to fulfill the inferencing request. A computer program product, according to one embodiment, includes a computer readable storage medium having program instructions embodied therewith. The program instructions are readable and/or executable by a computer to cause the computer to perform the foregoing method.

### BACKGROUND

The present invention relates to foundation models, and more specifically, this invention relates to using a logical tree structure to identify a foundation model inferencing server for fulfilling an inferencing request.

A typical conventional artificial intelligence (AI) model is typically trained using a set of data that is specifically tailored for that AI model. For example, tens of thousands of labeled examples are sometimes used to train some conventional AI models to summarize bodies of text. In contrast, foundation models are models that are trained on a broad set of unlabeled data that can be used for different tasks, with minimal fine-tuning. Furthermore, foundation models are relatively large models that are trained in a semi-supervised manner using a “masking” approach. A key advantage of a foundation model is that one pre-trained model can be fine-tuned for multiple downstream tasks.

### SUMMARY

A computer-implemented method, according to one embodiment, includes determining a plurality of downstream task models of a foundation model, and arranging the downstream task models into a logical tree structure. Each node of the logical tree structure represents a sequence of layers of an associated one of the downstream task models. In response to a determination that a request for inferencing on a target model has resulted in a cache miss occurring, the logical tree structure is used to identify an inferencing server that satisfies at least a first predetermined prerequisite for fulfilling the inferencing request. The method further includes causing the identified inferencing server to fulfill the inferencing request.

A computer program product, according to one embodiment, includes a computer readable storage medium having program instructions embodied therewith. The program instructions are readable and/or executable by a computer to cause the computer to perform the foregoing method.

A system, according to one embodiment, includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2A is a flowchart of a method, in accordance with one embodiment of the present invention.

FIG. 2B is a flowchart of sub-operations of an operation of the flowchart of FIG. 2A, in accordance with one embodiment of the present invention.

FIG. 3 is a representation of logical tree structure, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for using a logical tree structure to identify a foundation model inferencing server for fulfilling an inferencing request.

In one general embodiment, a computer-implemented method includes determining a plurality of downstream task models of a foundation model, and arranging the downstream task models into a logical tree structure. Each node of the logical tree structure represents a sequence of layers of an associated one of the downstream task models. In response to a determination that a request for inferencing on a target model has resulted in a cache miss occurring, the logical tree structure is used to identify an inferencing server that satisfies at least a first predetermined prerequisite for fulfilling the inferencing request. The method further includes causing the identified inferencing server to fulfill the inferencing request.

In another general embodiment, a computer program product includes a computer readable storage medium having program instructions embodied therewith. The program instructions are readable and/or executable by a computer to cause the computer to perform the foregoing method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as inventive code of block 200 for using a logical tree structure to identify a foundation model inferencing server for fulfilling an inferencing request. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

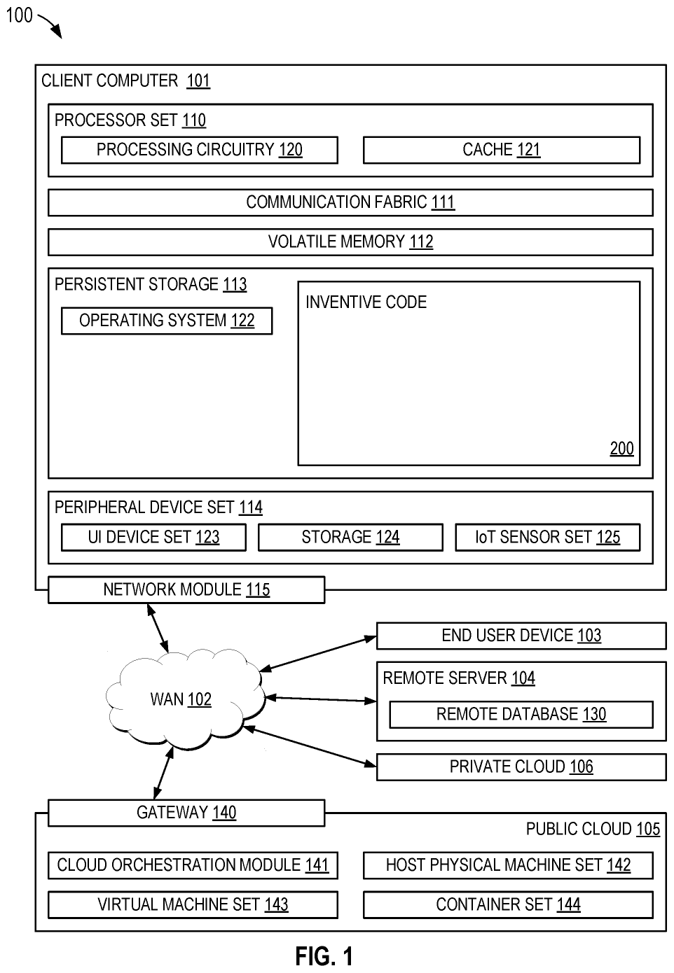

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere herein, a typical conventional artificial intelligence (AI) model is typically trained using a set of data that is specifically tailored for that AI model. For example, tens of thousands of labeled examples are sometimes used to train some conventional AI models to summarize bodies of text. In contrast, foundation models are models that are trained on a broad set of unlabeled data that can be used for different tasks, with minimal fine-tuning. Furthermore, foundation models are relatively large models, e.g., typically one hundred million plus parameter models, that are trained in a semi-supervised manner using a “masking” approach. A key advantage of a foundation model is that one pre-trained model can be fine-tuned for multiple downstream tasks.

One primary disadvantage of conventional use of foundation models is that such models tend to be large in size and thus incur higher inferencing cost. Accordingly, in order to establish a feasibility of using foundation models, there is a need to relatively reduce memory pressure associated with performance of foundation model inferencing. In sharp contrast to conventional techniques for using foundation models which are associated with relatively high amount of memory pressure, the novel techniques of various embodiments and approaches described herein reduce the memory pressure during model inferencing. More specifically, unlike prior deep learning models in which “N” models share no commonality in weights, in foundation models multiple downstream models may be trained using the same pre-trained model. In many cases, a large percentage of the base model is frozen and only the classification/regression head is trained. This results in multiple downstream models whose first N layers are identical and only the last few layers (the heads) are unique to the downstream task. The novel techniques of various embodiments and approaches described herein exploit an identification of these identical layers versus unique layers in order to reduce memory pressure. As will be described herein, an inferencing server may be caused to exploit this commonality between multiple downstream task models and ensure that the common components are loaded only once in the memory, thus alleviating memory pressure.

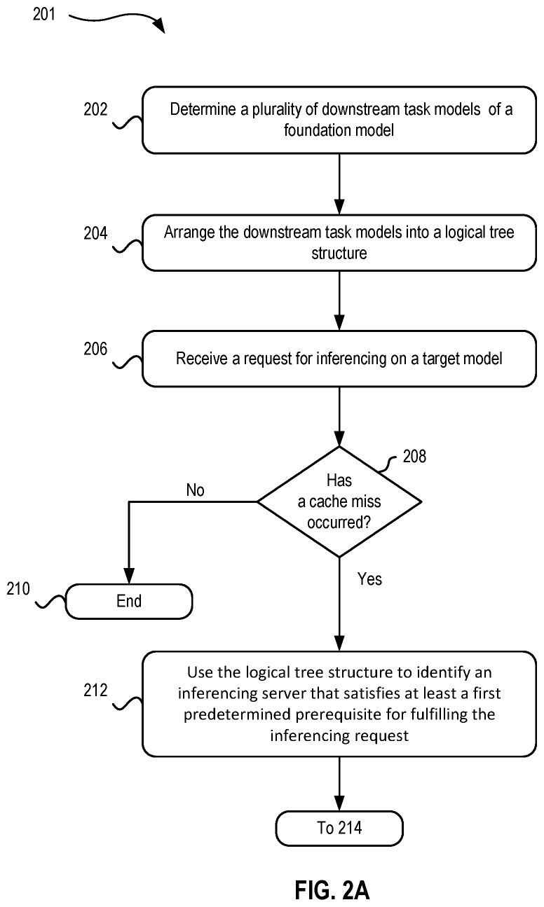

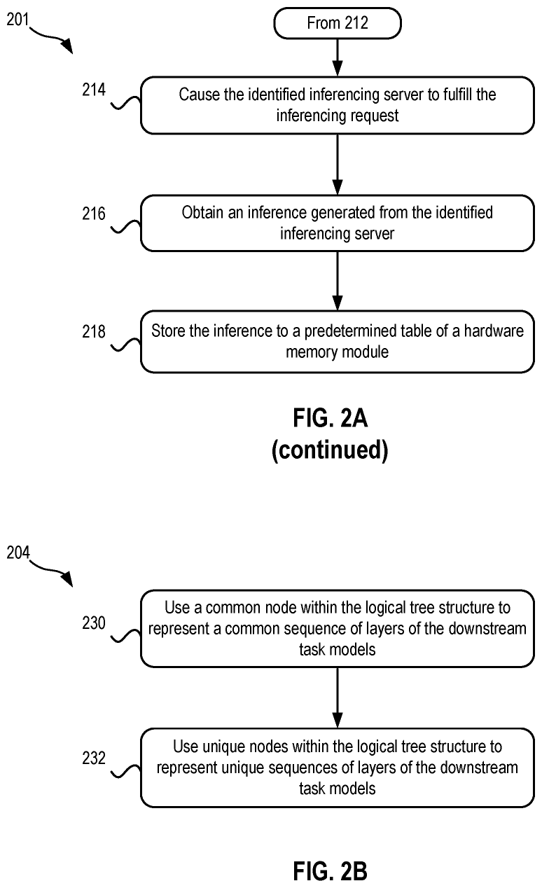

Now referring to FIG. 2A, a flowchart of a method 201 is shown according to one embodiment. The method 201 may be performed in accordance with the present invention in any of the environments depicted in FIGS. 1-3, among others, in various embodiments. Of course, more or fewer operations than those specifically described in FIG. 2 may be included in method 201, as would be understood by one of skill in the art upon reading the present descriptions.

Each of the steps of the method 201 may be performed by any suitable component of the operating environment. For example, in various embodiments, the method 201 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 201. Illustrative processors include, but are not limited to, a central processing unit (CPU), an application specific integrated circuit (ASIC), a field programmable gate array (FPGA), etc., combinations thereof, or any other suitable computing device known in the art.

Operation 202 includes determining a plurality of downstream task models of a foundation model. In some approaches, the plurality of downstream task models may be a zoo of downstream task models. The foundation model my be of a known type that would become apparent to one of ordinary skill in the art upon reading the descriptions herein. Task models that are “downstream” of the foundation model may in some approaches depend on the use case of the foundation model. Accordingly, in one or more of such approaches, the term “downstream” may refer to task models that are anticipated to be used based on a predetermined use case of the foundation model. For example, the foundation model may be initially trained on the English language, but thereafter have a need to be trained by at least one downstream task model for sentiment analysis, a need to be trained by at least one downstream task model for questioning and answering analysis, etc. In some approaches, training using downstream task models may include taking the base model, e.g., the English language task model in the current example, and convert the base model to perform a downstream task model. For example, in a continued context of the current example, this conversion may include freezing a predetermined number of layers of the based model, e.g., the layers associated the English language, and updating only a second predetermined number of the last layers of the base model, e.g., in order to produce a task specific model for sentiment analysis.

The downstream task models may additionally and/or alternatively include text based task models. For example, in some approaches, the downstream task models include, e.g., GLUE benchmark for natural language processing (NLP) which may itself have around eighteen different downstream task models, Stanford Question Answering Dataset (SQUAD) 1.0 text-based benchmarks, SQUAD 2.0 text-based benchmarks, sentiment analysis task models, questioning and answering task models, known types of task models, etc.

Operation 204 includes arranging the downstream task models into a logical tree structure. In some preferred approaches, the logical tree structure may include a plurality of nodes, e.g., leaf nodes. Each node of the logical tree structure may, in some approaches, represent a sequence of layers (with trained weights) of an associated one of the downstream task models. At least some layers of the downstream task models may about match and/or exactly match. In contrast, at least some layers of two or more of the downstream task models may not match, e.g., are unique. For example, looking to FIG. 2B, exemplary sub-operations for arranging downstream task models into a logical tree structure are illustrated in accordance with one embodiment, one or more of which may be used to perform operation 204 of FIG. 2A. However, it should be noted that the sub-operations of FIG. 2B are illustrated in accordance with one embodiment which is in no way intended to limit the invention. Arrangement of these unique layers and other layers of the downstream task models that match, in some approaches, may include using a common node within the logical tree structure to represent a common sequence of layers of the downstream task models, e.g., see sub-operation 230. This way, the logical tree structure captures the commonality between the different models, e.g., represented by a chain of leaf nodes. Unique nodes within the logical tree structure may additionally and/or alternatively be used to represent unique sequences of layers of the downstream task models, e.g., see sub-operation 232. This way, concatenation of the layers along a path from a root node to the leaf, e.g., where the leaf is a node relatively most distanced in the logical tree structure from the root node, may represent a model. Furthermore, in some approaches, concatenation of layers along a path from the root node to (and including) an intermediate node in the tree represents a partial model. For context, an “intermediate node” may be defined as a last node that is associated with matching layers of more than one downstream task model. This way, immediately after (and not including) the intermediate node, a partial path of the logical tree structure continues to branch-out along unique nodes that are associated with a single downstream task model.

With reference again to FIG. 2A, operation 206 includes receiving a request for inferencing on a target model. For context, in some approaches, the request may be to use the target model to make an inference which may be incorporated into training of the foundation model. In another approach, the request may be to use the target model, and thereby tune the foundation model to be applied to a downstream task.

The request may be issued to a plurality of predetermined inferencing servers, e.g., foundation model inferencing servers. In some approaches, one or more of these inferencing servers may have one or more models loaded that are represented by nodes of the logical tree structure. For example, a first of the inferencing servers may have the target model loaded. In response to a determination that each of the layers of the target model are represented by nodes in the logical tree structure, it may be determined that an associated one of the inferencing servers, e.g., the first inferencing server, has the target model fully loaded. Accordingly, the first inferencing server may be used to fulfill the inferencing request. In this case, because the first inferencing server has the target model fully loaded, a cache miss does not occur, or is relatively unlikely to occur. In contrast, in some approaches, a cache miss may occur based on the target model not being fully loaded on any of the inferencing servers that are considered as candidates for the inferencing request. In some preferred approaches, the inferencing servers that are considered as candidates for the inferencing request are the inferencing servers that currently each have one or more models loaded, where these loaded models have layers represented by nodes of the logical tree structure. Note that there is a potential that a portion of the target model may be loaded on the one or more of the inferencing servers represented by nodes of the logical tree structure. For example, in one approach, the first inferencing server may have a portion, but not all, of the target model loaded. However, because none of the inferencing servers have the target model fully loaded, the cache miss occurs. There is also a potential that, in some approaches, none of the inferencing servers have any of the target model loaded. For example, the cache miss may occur based on the target model being recently added as a new model serving instance. In such an example, based on the target model being recently added as a new model serving instance, none of the inferencing servers may have loaded even a portion of the new target model yet. In one or more of such approaches, in which none of the inferencing servers have any of the target model loaded, method 201 optionally includes selecting an inferencing model for loading the target model. In some approaches, an inferencing server that has a relatively largest residual computing capacity may be determined and selected to load the target mode.

It may be determined whether a cache miss associated with the received inferencing request has occurred, e.g., see decision 208. In response to a determination that a cache miss has not occurred, e.g., as illustrated by the “No” logical path of decision 208, the method optionally ends, e.g., see operation 210. In some approaches, it may be determined that a cache miss has not occurred based on, e.g., a predetermined cache miss flag not being set, a determination that an inference has been obtained based on inferencing being performed on the target model by one of the inferencing servers, a cache miss notification not being received, etc. It should be noted that although operation 210 notes that the method may optionally be ended, the logical tree structure may ongoingly be updated thereafter and/or detection of a cache miss may thereafter be performed in some approaches. In contrast, it may be determined that a cache miss has occurred, e.g., as illustrated by the “Yes” logical path of decision 208. In some approaches, it may be determined that a cache miss has occurred based on, e.g., a predetermined cache miss flag being set, a determination that inferencing is not initiated on the target model by one of the inferencing servers, a cache miss notification being received, etc.

In response to a determination that a request for inferencing on the target model has resulted in a cache miss occurring, the logical tree structure is used to identify an inferencing server that satisfies at least a first predetermined prerequisite for fulfilling the inferencing request, e.g., see operation 212. The predetermined prerequisite may, in some approaches, be based on one or more performance parameters of the inferencing server. This way, an inferencing server having relatively distinguished performance parameters, e.g., distinguished from the performance parameters of other inferencing servers, may be selected to use to fulfill the request. Various examples of predetermined prerequisites are described below.

In some approaches, a predetermined prerequisite may specify that an inferencing server have a relatively larger portion of the target model pre-loaded than any of the other inferencing servers that are considered as candidates for the inferencing request. For context, the less of the target model that an inferencing server has loaded, the more that the inferencing server is forced to load in the event the inferencing server is selected for fulfill the inferencing request. Accordingly, in some preferred approaches of method 201, include using an inferencing server determined to have a relatively larger portion of the target model pre-loaded than any of the other inferencing servers as the identified server to fulfill the inferencing request. The relatively largest portion of the target model may be identified as a directly connected chain of nodes, e.g., that branches outwards from the root, that constitutes a relatively largest portion of the target model. Using such a predetermined prerequisite reduces an amount of processing, e.g., memory pressure, that would otherwise be performed (in order to obtain an inference) if another inferencing model was alternatively used to fulfill the inferencing request.

In another approach, another predetermined prerequisite may specify that a residual capacity of an inferencing server be capable of loading a remainder of the target model. As a result of implementing such a predetermined prerequisite, it may be determined whether an inferencing server that is considered as a candidate for the inferencing request, has a sufficient amount of residual capacity that is needed to perform the inferencing while fulfilling the inferencing request. An amount of the target model that an inferencing server has loaded may be different than other inferencing servers, and therefore the amount of residual capacity that an inferencing server needs to have to be capable of loading a remainder of the target model may be different among the different inferencing servers. Techniques that would become apparent to one of ordinary skill in the art upon reading the descriptions herein may be used to determine a residual compute capacity of a given one of the inferencing servers and/or to determine an amount of compute capacity that loading a remainder of the target model, e.g., the portion of the target not yet loaded by an inferencing server, will take. In some approaches, the residual compute capacity of an inferencing server may be compared to an amount of compute capacity that loading a remainder of the target model will take. In response to a determination that the residual compute capacity of an inferencing server does not exceed an amount of compute capacity that loading a remainder of the target model will take, the inferencing server is removed from consideration as a candidate for the inferencing request. In contrast, in response to a determination that the residual compute capacity of an inferencing server exceeds an amount of compute capacity that loading a remainder of the target model will take, the inferencing server may remain in consideration as a candidate for the inferencing request.

In response to the determination that the inferencing request has resulted in the cache miss occurring, in some approaches, more than one predetermined prerequisite may be used, e.g., two predetermined prerequisites, three predetermined prerequisites, etc., to identify the inferencing server for fulfilling the inferencing request. This way, a combination of predetermined prerequisites may be used to determine optimal placement of the request instance to an inferencing server. For example, in one preferred approach, the logical tree structure is used to identify an inferencing server that satisfies a first predetermined prerequisite for fulfilling the inferencing request and a second predetermined prerequisite for fulfilling the inferencing request. For example, in such an approach, the first predetermined prerequisite may specify that a residual capacity of an inferencing server be capable of loading a remainder of the target model. Furthermore, the second predetermined prerequisite may specify that an inferencing server have a relatively larger portion of the target model pre-loaded than any of the other inferencing servers that are considered as candidates for the inferencing request.

A plurality of the inferencing servers that are considered as candidates for the inferencing request may, in some approaches, be determined to satisfy one or more of the predetermined prerequisites. For example, it may be assumed that the determination of an inferencing server for fulfilling the inferencing request is based on a first predetermined prerequisite specifies that an inferencing server have a relatively larger portion of the target model pre-loaded than any of the other inferencing servers that are considered as candidates for the inferencing request. In such an example, in response to determining that more than one of the inferencing servers have a relatively largest portion of the target model pre-loaded, e.g., both are associated with a relatively longest chain of directly connected nodes in the logical tree structure, one of the inferencing servers having the relatively largest portion of the target model pre-loaded may be randomly selected to fulfill the inferencing request. In another example, it may be assumed that the determination of an inferencing server for fulfilling the inferencing request is additionally and/or alternatively based on a second predetermined prerequisite specifies that a residual capacity of an inferencing server be capable of loading a remainder of the target model. In such an approach, a third predetermined prerequisite may additionally and/or alternatively be applied that specifies that an inferencing server with a relatively greatest residual capacity be selected as the inferencing server for fulfilling the inferencing request. Note that, in the unlikely event that more than one of the inferencing servers are determined to have the same residual capacity, another predetermined prerequisite may be applied and/or a random one of the inferencing servers having matching residual capacities may be selected as the inferencing server for fulfilling the inferencing request.

Method 201 may optionally include applying different weightage values to a determination of which of the plurality of interfacing servers to use to fulfill the inferencing request. For example, in some approaches, relatively more significant weightage values, e.g., relatively greater weightage values, may be assigned to one of the predetermined prerequisites, and relatively less significant weightage values, e.g., relatively less weightage values, may be assigned to another one of the predetermined prerequisites. Thereafter, predetermined prerequisites having relatively higher weightage values may be prioritized relatively more than predetermined prerequisites having relatively lower weightage values in the determination of an inferencing server for fulfilling the inferencing request.

Operation 214 includes causing the identified inferencing server to fulfill the inferencing request. In one approach, causing the identified inferencing server to fulfill the inferencing request may include issuing an instruction to the identified inferencing server to fulfill the request. It should be noted that, the identified inferencing server is caused to load only a portion of the target model, e.g., the portion of the target model that is not pre-loaded on the identified inferencing server, to fulfilling the inferencing request. Furthermore, the identified inferencing server may be caused to not fully load the target model, e.g., not load a portion of the target model that the identified inferencing server already has loaded. Performance in a computer related environment of inferencing servers in which method 201 is performed is relatively improved as a result of memory pressure being alleviated. This memory pressure is alleviated by the identified inferencing server only loading the portion of target model rather than the entire target model being otherwise loaded.

Operation 216 includes obtaining an inference generated from the identified inferencing server. The inference may, in some approaches, be obtained subsequent to the identified inferencing server loading the portion of the target model and fulfilling the inferencing request. In contrast, in some approaches, at least some of the inference may be obtained before the loading of the portion of the target model it completed and/or initiated. For example, in some approaches, method 201 includes issuing an instruction to the identified inferencing server to start inferencing on the partial model that is already loaded in the inferencing server, while loading the remaining layers of the model. In some cases, this may result in the cost of model loading being partially or entirely masked, which further improves performance in a computer related environment of inferencing servers. This is because the loading and inferencing may be instructed to be performed in a parallel manner, which concludes at about the same time.

Operation 218 includes storing the inference to a predetermined table of a hardware memory module.

It should be noted that in some computer related environment of inferencing servers, the logical tree structure may include a predetermined maximum threshold number of nodes, e.g., where no more than the predetermined maximum threshold number of nodes are allowed to be added in the logical tree structure. Accordingly, method 201 optionally may include implementing a predetermined cache replacement policy for nodes in the model tree structure. For example, the predetermined cache replacement policy may specify that relatively least recently used (LRU) nodes of the model tree structure are evicted first to create node space for new nodes. In another approach, nodes in the model tree structure that are associated with an outdated model, e.g., that is being phased out, may be evicted to create node space for new nodes.

Numerous benefits are enabled as a result of implementing the techniques described herein in a computer related environment of inferencing servers in which a foundation model is used. For example, it should be noted that it is very typical to have a plurality, e.g., ten to twenty or more, of downstream tasks models, e.g., GLUE benchmark for NLP, of a foundation model. In order to realize the alleviation of memory pressure enabled by the techniques described herein, it may be assumed for purposes of an example that each of ten downstream models are 4 gigabytes (GB) in size and they all share 90% of a base pre-trained model. Conventional approaches would otherwise load the ten models which would require forty GB of memory pressure, e.g., 4 GB*10 models=40 GB of memory pressure. In sharp contrast, the novel techniques described herein exploit the commonality among models to alleviate memory pressure.

Accordingly, using these novel techniques for loading these ten models would include only 7.6 GB of memory pressure, based on use of pre-loaded portions of a model rather than loading an entire model. For example, to load these ten models requires 3.6 GB+10 models*0.4 GB=7.6 GB, where the 3.6 GB is an initial load of portions of the models that match, and 0.4 GB represents portions of each model that do not match with other models. It should also be noted that use of a logical tree structure to identify a foundation model inferencing server for fulfilling an inferencing request has not been considered in conventional applications. In sharp contrast, conventional approaches load entire models to fulfill inferencing requests, which creates considerable memory pressure. Accordingly, the inventive discoveries disclosed herein with regards to use of a logical tree structure to identify a foundation model inferencing server for fulfilling an inferencing request proceed contrary to conventional wisdom.

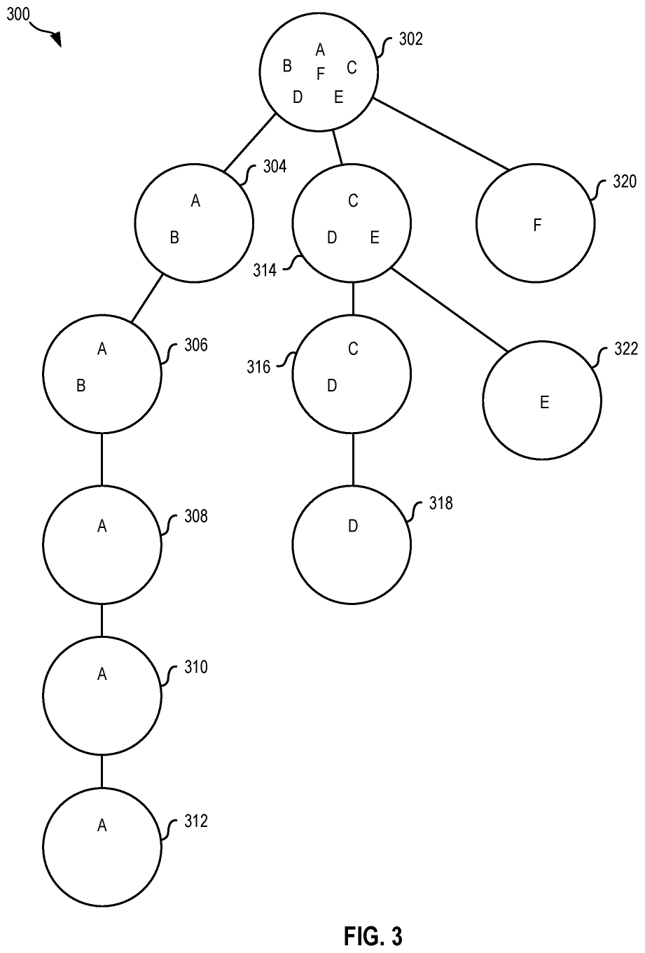

FIG. 3 depicts a representation of logical tree structure 300, in accordance with one embodiment. As an option, the present logical tree structure 300 may be implemented in conjunction with features from any other embodiment listed herein, such as those described with reference to the other FIGS. Of course, however, such logical tree structure 300 and others presented herein may be used in various applications and/or in permutations which may or may not be specifically described in the illustrative embodiments listed herein. Further, the logical tree structure 300 presented herein may be used in any desired environment.

A plurality of downstream task models determined for a foundation model are arranged into the logical tree structure 300. Arranging the task models into the logical tree structure, in some approaches, includes using a common node within the logical tree structure to represent a common sequence of layers of the downstream task models, e.g., from a root node to intermediate nodes which include nodes 306, 316, 314 and 302 (note that 302 is the root node and intermediate node for an inferencing server represented by the letter “F”). Arranging the task models into the logical tree structure, in some approaches, additionally includes using unique nodes within the logical tree structure to represent unique sequences of layers of the downstream task models, e.g., see nodes 308, 310, 312, 318, 320 and 322. In FIG. 3, nodes that include a plurality of letters are common nodes, while nodes that include a single letter are unique nodes. Each of the letters represent an extent that a given inferencing server has pre-loaded a task model. For example, a first inferencing server represented by the letter “A” has sequences of layers of a downstream task model that are arranged from a root node 302, to a second node 304, to an intermediate third node 306, to a fourth node 308, to a fifth node 310, and stop at a sixth node 312. It may be noted that the first inferencing server has relatively more of the downstream task model pre-loaded than a second inferencing server represented by the letter “B.” This is because the second inferencing server represented by the letter “B” has sequences of layers of the downstream task model that are arranged from the root node 302, to the second node 304, and stop at the intermediate third node 306. It may also be noted that the first inferencing server has relatively more of the downstream task model pre-loaded than a third inferencing server represented by the letter “C,” a fourth inferencing server represented by the letter “D,” a fifth inferencing server represented by the letter “E,” and a sixth inferencing server represented by the letter “F.”

In response to a determination that a request for inferencing on a target model has resulted in a cache miss occurring, the logical tree structure may be used to identify an inferencing server that satisfies at least a first predetermined prerequisite for fulfilling the inferencing request. For example, in one approach, the first predetermined prerequisite may specify that an inferencing server have a relatively larger portion of the target model pre-loaded than any of the other inferencing servers that are considered as candidates for the inferencing request. In the logical tree structure 300, the first inferencing server represented by the letter “A” satisfies the first predetermined prerequisite. Accordingly, the first inferencing server may be caused, e.g., instructed, to fulfill the inferencing request.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
determining a plurality of downstream task models of a foundation model;
arranging the downstream task models into a logical tree structure, wherein each node of the logical tree structure represents a sequence of layers of an associated one of the downstream task models;
in response to a determination that a request for inferencing on a target model has resulted in a cache miss occurring, using the logical tree structure to identify an inferencing server that satisfies at least a first predetermined prerequisite for fulfilling the inferencing request; and
causing the identified inferencing server to fulfill the inferencing request.

2. The computer-implemented method of claim 1, wherein the cache miss occurs based on the target model not being fully loaded on any inferencing servers that are considered as candidates for the inferencing request.

3. The computer-implemented method of claim 2, wherein the first predetermined prerequisite specifies that a residual capacity of an inferencing server be capable of loading a remainder of the target model.

4. The computer-implemented method of claim 3, comprising: in response to the determination that the inferencing request has resulted in the cache miss occurring, using the logical tree structure to identify an inferencing server that satisfies the first predetermined prerequisite for fulfilling the inferencing request and a second predetermined prerequisite for fulfilling the inferencing request, wherein the second predetermined prerequisite specifies that an inferencing server have a relatively larger portion of the target model pre-loaded than any of the other inferencing servers that are considered as candidates for the inferencing request.

5. The computer-implemented method of claim 4, wherein a plurality of the inferencing servers that are considered as candidates for the inferencing request are determined to satisfy the first predetermined prerequisite and the second predetermined prerequisite, and comprising: applying different weightage values to a determination of which of the plurality of interfacing servers to use to fulfill the inferencing request.

6. The computer-implemented method of claim 1, wherein the first predetermined prerequisite specifies that an inferencing server have a relatively larger portion of the target model pre-loaded than any of the other inferencing servers that are considered as candidates for the inferencing request, wherein the identified inferencing server is determined to have a relatively largest portion of the target model pre-loaded.

7. The computer-implemented method of claim 1, wherein arranging the downstream task models into the logical tree structure includes: using a common node within the logical tree structure to represent a common sequence of layers of the downstream task models, and using unique nodes within the logical tree structure to represent unique sequences of layers of the downstream task models.

8. The computer-implemented method of claim 1, wherein the identified inferencing server is caused to load only a portion of the target model to fulfilling the inferencing request.

9. The computer-implemented method of claim 1, comprising: obtaining an inference generated from the identified inferencing server; and storing the inference to a predetermined table of a hardware memory module.

10. The computer-implemented method of claim 1, wherein the downstream task models are selected from the group consisting of: natural language processing (NLP) task models, sentiment analysis task models, and questioning and answering task models.

11. A computer program product, the computer program product comprising a computer readable storage medium having program instructions embodied therewith, the program instructions readable and/or executable by a computer to cause the computer to:
determine, by the computer, a plurality of downstream task models of a foundation model;
arrange, by the computer, the downstream task models into a logical tree structure, wherein each node of the logical tree structure represents a sequence of layers of an associated one of the downstream task models;
in response to a determination that a request for inferencing on a target model has resulted in a cache miss occurring, use, by the computer, the logical tree structure to identify an inferencing server that satisfies at least a first predetermined prerequisite for fulfilling the inferencing request; and
cause, by the computer, the identified inferencing server to fulfill the inferencing request.

12. The computer program product of claim 11, wherein the cache miss occurs based on the target model not being fully loaded on any inferencing servers that are considered as candidates for the inferencing request.

13. The computer program product of claim 12, wherein the first predetermined prerequisite specifies that a residual capacity of an inferencing server be capable of loading a remainder of the target model.

14. The computer program product of claim 13, the program instructions readable and/or executable by the computer to cause the computer to: in response to the determination that the inferencing request has resulted in the cache miss occurring, use, by the computer, the logical tree structure to identify an inferencing server that satisfies the first predetermined prerequisite for fulfilling the inferencing request and a second predetermined prerequisite for fulfilling the inferencing request, wherein the second predetermined prerequisite specifies that an inferencing server have a relatively larger portion of the target model pre-loaded than any of the other inferencing servers that are considered as candidates for the inferencing request.

15. The computer program product of claim 14, wherein a plurality of the inferencing servers that are considered as candidates for the inferencing request are determined to satisfy the first predetermined prerequisite and the second predetermined prerequisite, and the program instructions readable and/or executable by the computer to cause the computer to: apply, by the computer, different weightage values to a determination of which of the plurality of interfacing servers to use to fulfill the inferencing request.

16. The computer program product of claim 11, wherein the first predetermined prerequisite specifies that an inferencing server have a relatively larger portion of the target model pre-loaded than any of the other inferencing servers that are considered as candidates for the inferencing request, wherein the identified inferencing server is determined to have a relatively largest portion of the target model pre-loaded.

17. The computer program product of claim 11, wherein arranging the downstream task models into the logical tree structure includes: using a common node within the logical tree structure to represent a common sequence of layers of the downstream task models, and using unique nodes within the logical tree structure to represent unique sequences of layers of the downstream task models.

18. The computer program product of claim 11, wherein the identified inferencing server is caused to load only a portion of the target model to fulfilling the inferencing request.

19. The computer program product of claim 11, the program instructions readable and/or executable by the computer to cause the computer to: obtain, by the computer, an inference generated from the identified inferencing server, and store, by the computer, the inference to a predetermined table of a hardware memory module.

20. A system, comprising:
a processor; and
logic integrated with the processor, executable by the processor, or integrated with and executable by the processor, the logic being configured to:
determine a plurality of downstream task models of a foundation model;
arrange the downstream task models into a logical tree structure, wherein each node of the logical tree structure represents a sequence of layers of an associated one of the downstream task models;
in response to a determination that a request for inferencing on a target model has resulted in a cache miss occurring, use the logical tree structure to identify an inferencing server that satisfies at least a first predetermined prerequisite for fulfilling the inferencing request; and
cause the identified inferencing server to fulfill the inferencing request.
